(19) United States
(12) Patent Application Publication
(10) Pub. No.: US 2008/0235118 A1
(43) Pub. Date: Sep. 25, 2008

(54) Debt Monitoring System

(76) Inventor: Paul Steven Stemp, Nerang (AU)

Correspondence Address: SHOEMAKER AND MATTARE, LTD, 10 POST OFFICE ROAD - SUITE 110, SILVER SPRING, MD, 20910, US

(21) Appl. No.: 12/052,116

(22) Filed: Mar. 20, 2008

(30) Foreign Application Priority Data
Mar. 21, 2007 (AU) 2007901461

(51) Int. Cl. G06Q 50/00

(52) U.S. Cl. 705/30

(57) ABSTRACT

A debt monitoring system for use by suppliers of a service such as child care centers which provide child care services to a number of users, the child care centres being provided with a computer having data recording means for recording data of each user of the service provided by that child care centre, the data including debt and payment records of the users and central data recording means which can upload the user data from the computer of each child care centre and analyse the data to determine users who default in payment to the child care centre. The debt monitoring system can also be applied to other suppliers of goods and/or services to a plurality of purchasers.

### TECHNICAL FIELD

This invention relates to a debt monitoring system and in particular to a computerized debt monitoring system which may be used in combination with a debt recovery system. The system of the present invention has a particular use in the child care industry but also applicable to other industries including industries where goods and/or services are supplied on credit.

### BACKGROUND ART

Debt monitoring and debt recovery is a common difficulty encountered in the childcare industry. This difficulty is accentuated as information relating to persons who enroll their child in one particular centre including information relating to a person's debt payment history cannot be shared between child care centers because of existing privacy laws. Thus a common problem which arises is that a person may enroll their child in one child care centre and not pay for the services provided by that centre for a number of weeks although obtaining during that period child care services rendered by the centre. When that person, through non payment of the child care fees, is asked to leave the centre, or alternatively leaves of their own accord, that person may simply move to the next centre and again receive child care services from that latter centre for a period without payment as that centre will be unaware of the payment history of that person. The pattern can then repeat so that an unethical person can obtain child care services from different child care centres over an extended period without payment.

The above described problem is relatively common and results overall in a large loss of income to a childcare centre and to the industry as a whole. The above problems are also encountered where goods or services are supplied on credit, that is without receiving payment up front or at the point of sale. Thus persons obtaining goods or services on credit from one supplier can obtain goods or services from other supplies without the other supplier being aware of a debt owing to the first supplier.

### SUMMARY OF THE INVENTION

The present invention aims to provide a debt monitoring system which enables debts incurred by a user of goods and/or services provided by a supplier on credit to be monitored. The present invention further aims to provide a system in which the debt history of a person who is supplied with goods or services from suppliers is accessible to other suppliers so that suppliers can reduce the risks of incurring bad debts. The present invention in a further aspect aims to provide a debt recovery system which facilitates the recovery of debts from persons owing monies to suppliers. In a particular aspect, the present invention aims to provided a debt monitoring system which enables debts incurred by users of different child care centers to be monitored and which enables the debt history of a person who enrolls a child in a child care centre to be accessible to other child care centres so that child care centres can reduce the risks of incurring bad debts. Whilst the present invention is primary applicable to child care centres where debts from persons enrolling their children in such centres commonly arises, the present invention is also applicable to other equivalent situations such as to other service providing industries or other suppliers in which goods and/or services are supplied on credit. Other objects and advantages of the invention will become apparent from the following description.

The present invention thus provides in one aspect, a debt monitoring system for use by a plurality of suppliers which supply goods and/or services on credit to respective purchasers of those goods and/or services, each said supplier having data recording means for recording data of each said purchaser, said data including debts to said supplier in respect of goods and/or services provided or to be provided by said supplier to said purchaser and payment records in relation to said debts, and central data recording means for recording said purchaser data from said plurality of suppliers, means for transferring said purchaser data from the data recording means of respective said suppliers to said central data recording means, and means for determining from said transferred purchaser data, the purchasers who do not meet payment conditions prescribed by a said supplier for goods and/or services provided or to be provided by a said supplier.

Preferably the supplier's data recording means comprises a computer which is software programmed to receive and store data of all purchasers of the services and/or goods provided or to be provided by the supplier including debts owing and payment records. The transfer or uploading of purchaser data from the data recording means of a supplier to the central data recording means may be triggered automatically at regular time or date intervals for example weekly. Preferably the suppliers' software automatically transfers the purchaser data to the central data recording means. Alternatively the data may be transferred under the control of the supplier or as prompted from the central date recording means. The central data recording means suitably includes a central computer having common database in which the purchaser data of all users of suppliers may be recorded. Preferably the central computer is software programmed to analyse the purchasers' data held in the common database to determine from the payment records contained in the purchasers' data whether a debt has been paid so as to enable a list of defaulting or non-paying purchasers of suppliers to be established.

Preferably the list of defaulting purchaser of a supplier are provided to a supplier to enable the supplier to determine whether one or more defaulting purchasers should remain in the list of defaulting purchasers. Thus the supplier can elect to leave a purchaser on the list or remove a purchaser from the list. Preferably the defaulting purchaser list is provided to the supplier by email or by any other electronic communication means for example through a web site of the debt monitoring system and wherein means are provided to enable a said supplier to remove one or more purchasers from said list. Preferably the supplier can communicate electronically with the central data recording means by for example secure access to the web side of the debt monitoring system to remove one or more purchasers from the defaulter's list. Access to the website of the debt monitoring system may be by way of conventional means such as through a login name or identifier and password.

Means may be provided to credit rate defaulting purchases in the list of defaulting purchasers. The credit rating may comprise a numerical scale and based on the time a debit or account has been outstanding and/or the size of the outstanding debit or account. The credit rating may be provided with the list of defaulting purchasers. Preferably the rating of defaulting purchases is calculated automatically by the central computer during analysis of the payment records of purchasers against the debts owing.

Preferably also the software of the central computer upon analysis of the purchaser data from respective suppliers can detect a defaulting purchaser from one supplier whose data is uploaded from another supplier. Thus a defaulting purchaser of one supplier can be located if that purchaser's data is uploaded from another supplier and that purchaser's date contains correct address and/or contact details. In the event that the defaulting purchaser is located, an alert notification such as an email can be sent to the one supplier so that collection action can be initiated if require by that one supplier. This information however is usually only available if the defaulting purchaser is a recorded purchaser of the other supplier and has agreed to the credit terms of that supplier (which allow for exchange of information relating to the purchaser with other suppliers) or if collection proceedings have been initiated by the other supplier against the defaulting purchaser in which case also information on the defaulting purchaser can be exchanged for the purposes of debt recovery and/or credit rating.

Preferably each supplier is required to be a member of the debt monitoring system and when a member of the debt monitoring system, is entitled to access to the common database of the central data recording means for example by a secure user name and password to view the list of defaulting purchasers of all member suppliers. A supplier is thus able to ascertain whether a person who wishes to use their services or be supplied with goods has a debt owing to any other supplier and therefore the supplier can adjust their credit terms accordingly or make a decision as to accepting that person or not as a customer.

The debt monitoring system may be such that each supplier is required to be a subscriber to the system and pay a fee such as an annual fee for services provided under the system. Subscribers however may not be required to pay a fee to be able to use the system.

The system may also nominate a debt collection agency accessible to the suppliers to facilitate recovery of debts due to the supplier. Preferably the common central database of the central data recording means is available to and accessible by the debt collection agency so that details such as name and address details of persons from whom debt recovery is required can be ascertained. A supplier may initiate debt collection proceedings directly with the debt collection agency or initiate debt collection proceedings through the debt monitoring system such as through the web site of the system.

The software program of the supplier into which data may be entered in relation to a purchaser or proposed purchaser of goods and/or services provided by a supplier and which is provided by the debt monitoring system may be used to communicate with and search the common database to retrieve information relating to that purchaser such as credit history of the purchaser. The software program may also be used for other communications between the central computer of the debt monitoring system.

Suppliers of services may typically comprise child care centers and thus the present invention in another aspect provides, a debt monitoring system for use by a plurality of child care centers which provide child care services to respective users, each said child care centre having data recording means for recording data of each user of the service provided by said child care centre, said data including debt and payment records of a said user for provided or to be provided by a said child care centre, and central data recording means for recording said user data from each child care centre, means for transferring said user data from the data recording means of respective said child care centers to said central data recording means, and means for determining from said transferred user data, defaulting users who do not meet payment conditions prescribed by a said child care center for child care services provided by a said child care centre.

The data recording means suitably comprises a computer and the transfer or uploading of user data from a child care centre to the central data recording means may be triggered automatically at regular time intervals. The data however may be transferred under the control of the child care centre for example by a key on the computer of the child care centre being pressed or a displayed icon on the screen of the computer being activated or as prompted from said central data recording means. The computer is suitably software programmed to record the user data of all users of the services provided by the child care centre including debt and payment records and all this information is transmitted or uploaded to the central data recording means at regular intervals. The central data recording means suitably includes a central computer having common database in which the user data of all users of child care centers may be recorded and the central computer may analyse the user data held in the common database to establish from the debt owing and payment records contained in the user data, a list of defaulting users of child care centers. Thus debt monitoring is undertaken in the central computer and not by the child care centre itself.

The list of defaulting users are suitably provided to the child care centre's computer to enable the child care centre to decide or determine whether one or more defaulting users should remain in the list of defaulting users. Thus the child care centre can elect to leave a user on the list or remove a user from the list. Preferably the defaulting user list is provided to the service provider by email or by any other electronic communication means for example through a web site of the debt monitoring system and the child care centre can similarly communicate with the central data recording means to remove one or more users from the defaulter's list.

Preferably also the software of the central computer upon analysis of the user data from respective child care centers can detect a defaulting user from one child care centre whose user data is uploaded from another child care centre. Thus a defaulting user of one child care centre can be located if that user's data is uploaded from another child care centre. In the event that the defaulting user is located, an alert notification such as an email can be sent to the one child care centre so that collection action can be initiated if require by that one child care centre. This information however is usually only available if the defaulting user is an enrolled user of the other child care centre and thus has agreed to the enrolment terms (which allow for exchange of information relating to the user with other service providers) or if collection proceedings have been initiated by the other child care centre against the defaulting user in which case also information on the defaulting user can be exchanged for the purposes of debt recovery and/or credit rating.

Child care centers who are members of the debt monitoring system are entitled to access to the common database for example by a secure user name and password to view the list of defaulting users of all member child care centers and therefore can ascertain the credit rating of a proposed user of their services and whether a debt is owing to any other child care centre. A child care centre can therefore adjust their credit terms accordingly or make a decision as to accepting that proposed user or not.

As above a rating system may be used to rate defaulting purchasers, the rating which may comprise a numeral or other indicator comprising a credit rating and being provided with the list of defaulting purchasers. Preferably the rating is determined automatically by the central computer during analysis of the payment records of purchasers against the debts owing.

Preferably the common central database is available for use by a debt collection agency so that details such as name and address details of users from whom debt recovery is required can be ascertained. A child care centre may initiate debt collection proceedings directly with the debt collection agency or initiate debt collection proceedings through the debt monitoring system such as through the web site of the system.

Whilst the system may be applied to child care centers as described above, it may also be applied to other service providers which provide services to users or purchasers on credit. It may also be applied to suppliers of goods who supply goods on credit to purchasers of goods.

### BRIEF DESCRIPTION OF THE DRAWINGS

In order that the invention may be more readily understood and put into practical effect, reference will now be made to the accompanying drawings which illustrate a preferred embodiment of the invention applied to the operation of a plurality of child care centers which provide child care services to a plurality of users usually on credit. The present invention however may be applied to other organizations or groups comprising a plurality of service providers, each of which provides services to a plurality of users or supplies or goods which supply goods to a plurality of purchasers on credit.

In the drawings:

FIG. 1 is a block diagram of a debt monitoring system applied to use with a plurality of child care centres; and

FIGS. 2A and 2B illustrates a flow diagram illustrating the transfer of information between the child care centres and the central data recording means.

### DETAILED DESCRIPTION OF THE PREFERRED EMBODIMENT

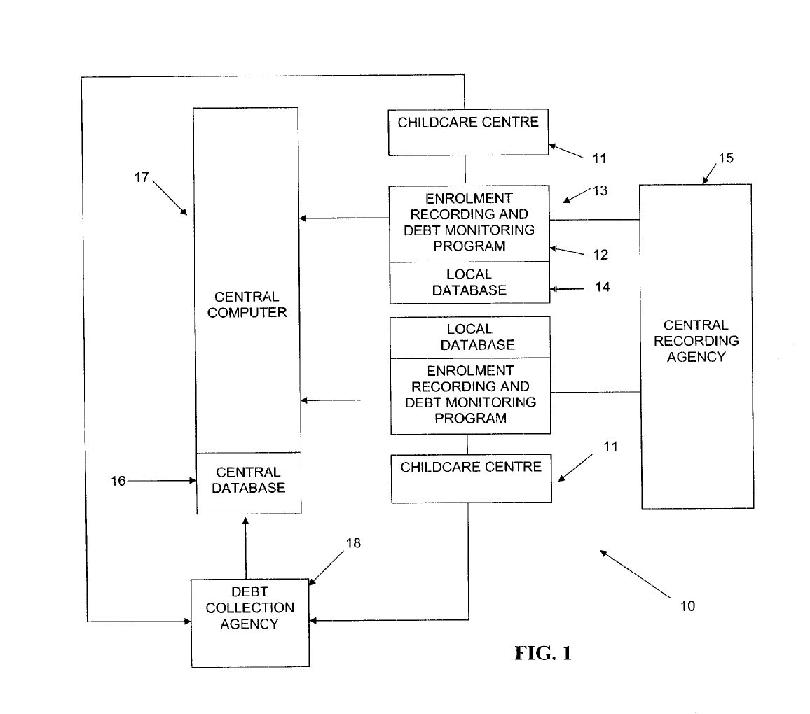

Referring to FIG. 1, there is illustrated a debt monitoring and recovery system 10 according to the present invention as used in relation to the child care industry in which child care services are provided by a plurality of service providers comprising child care centres 11. In the drawing, only two childcare centres 11 are shown as being part of the system 10 however it will be appreciated that the system 10 can include any number of childcare centres 11. Each childcare centre 11 provides an enrolment form generated by an enrolment recording and debt monitoring software program 12 held on a local computer 13 of the childcare centre, the software program 12 being provided as part of the system 10. Personal details of users are entered into the software-generated enrolment form by a user upon enrolment of children in the childcare centre 11. The enrolment form additionally provides terms and conditions for payment of debts and therefore serves as a credit application form which allows data on that form to be used and shared by others for the purposes of credit rating and debt recovery. The data on the enrolment form is stored in a local computer database 14 held by the childcare centre 11 and generated by the enrolment recording and debt monitoring software program 13. As an alternative, the enrolment data can be entered directly by filling in an on-screen enrolment form displayed on the monitor of the computer 13 for storing in the local database. The data thus entered into the local database 14 comprises information relating to the user such as information identifying contact details for example the name and address and telephone number of the user and further includes the debts owing for services provided and payment records of a user against those debts. All payments made by users are subsequently entered into the local database 14 using the software program 13 so that a record of a user's payment record against debts owing is regularly maintained and updated.

The local computer 13 of the child care centre 11 can additionally communicate through the enrolment recording software program 12 and typically via the internet with a central recording agency 15 usually a government agency which calculates and provides subsidies to the child care centre 11 in accordance with the information on a user or children recorded on the enrolment form and held within the local database 14. To obtain a subsidy provided by the central recording agency 15, the proposed user is required to enter correct information including address or contact information upon the enrolment form. The proposed user, if he or she already does not have one, is assigned a customer reference number (CRN) which is unique to that user.

The recording and debt monitoring program 12 of the local computer of the child care centres monitors the payment record of the user and can identify and flag when payments have not be paid by a user within a prescribed time limit for payment as set by an individual child care centre 11 and as set out on the enrolment form. This for example may be set at 7 days, 14 days, or 30 days at the option of the childcare centre 11.

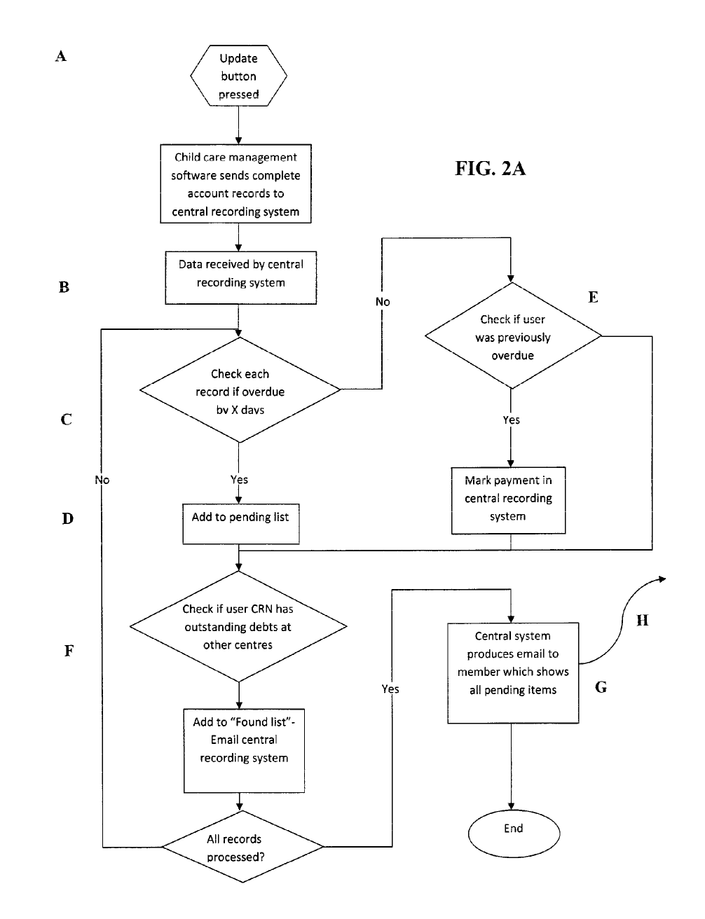

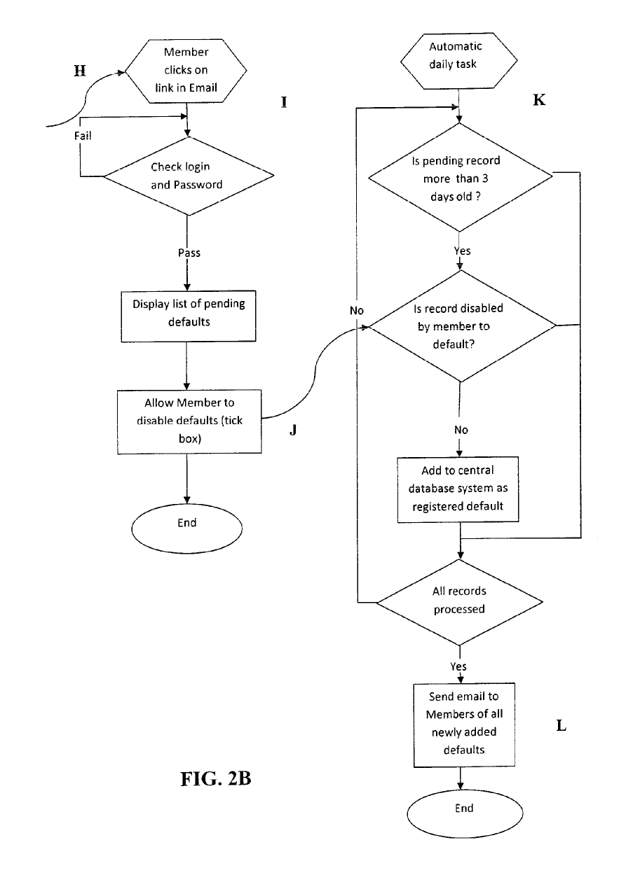

In the preferred embodiment however and as illustrated in the flow diagram of FIG. 2, the recording and debt monitoring program 12 of the childcare centre's local computer 13 has a facility which enables all recorded data relating to a user including debts owing and payment records to be transferred to a central common monitoring database 16 in a central monitoring computer 17 usually over a secure internet connection or by other communication means. The data may be encrypted for security purposes. Transfer of this data to the central database 16 may occur when actuated by the child care centre 11 for example by an operator pressing a key or clicking on an icon displayed on the monitor of the child care centre's computer 13 as illustrated at step A in FIG. 2. Alternatively the transfer of this user data to the central computer 17 can occur at regular intervals automatically such as weekly. In another alternative, a prompting message can be sent from the central monitoring computer 17 to the computers 13 of the child care centres to prompt a child care centre 11 to upload the required information to the central computer 17.

The central common monitoring database 16 held on the central monitoring computer 17 thus uploads data on all users of the respective child care centres 11 including their debts owing and payment records as in step B in FIG. 2A.

After uploading of the above user data from the respective child care centres 11 which comprises records of all users of child care services and their payment records, software in the central computer 17 analyses the record of each user in step C in FIG. 2a to ascertain whether user payments of debts owing are overdue and therefore whether users are defaulting users and how many days a user has been in default. A rating system is be used to rate users by whether a debt is owing or not and/or the period that the debt has been outstanding, the rating system being in this embodiment a numeral rating system. The rating is calculated automatically by the central computer 17 upon analysis of the payment records of users and is marked against defaulting user in the list of defaulting users. Thus a user who has no debt owing may be rated by the numeral 1. A debtor who is owing a relatively small amount and who has been owing the debt for a relatively short period of time, for example a debt less than $100 owing less than thirty days may be rated the numeral 2. A debtor who is owing a larger amount and who has owed the debt for a relatively long period of time for example a debt of over $200 owing for over sixty days may be rated the numeral 4. Debtors whose debt is between these ranges may be rated for example 2 to 4. A debtor against whom debt collection proceedings have been initiated may be rated numeral 6. Of course the rating system may be considerably varied and be in other forms than that described above.

The central computer software thus creates in the central database 16 as in step D in FIG. 2A a list of user debtors obtained from the user data from a plurality of childcare centres 11 with that list comprising contact information on the user such as a parent's name and address and their debt position in relation to a particular child care centre 11 together with their debt rating.

In addition, the software in step E in FIG. 2A can check whether a user who does not have an outstanding debt from their current user data, had a previously overdue debt. If that debt remains unpaid, information on that user is held in the database 16 but can only be added to the list of debtors if collection proceedings have been initiated against that user or unless at the time the debt was incurred they had agreed to the terms and conditions for enrolment in a child care centre under the system 10.

The central computer software can also undertake in step F a search to ascertain whether there are any debts owing under the customer reference number (CRN) of a user at any other centre. If any such debtors are located, they are added to the defaulter's list.

After establishing the final user defaulter's list as in step G in FIG. 2A, the central computer sends to each child care centre 11 as at H in FIGS. 2A and 2B the defaulter's list relating to that child care centre provider 11 under the password of that centre 11 and typically via email. The child care centre 11 is then able to access the emailed list of user defaulters through entry of their username and password. The child care centre 11 then is required to determine whether particular defaulters should remain on the list as at J in FIG. 2B. For example, a child care centre 11 may determine from the circumstances of a particular family, that they should not be retained on the list. This may be done by ticking a box on screen display on the monitor of the local computer 13 whilst online. Amendment of the list is required to be done within a predetermined period eg. 48 to 72 hours after receipt of the defaulter list so that the onus is on the child care centre 11 as to whether a defaulter should remain on the list. If there is no response from the child care centre 11, all users in the list will be automatically retained in the defaulter's list on the central database 16.

The central monitoring computer 17 updates its defaulter's list automatically as at K in FIG. 2B usually daily by reviewing each user record and checking to see if a record has been disabled by a child care centre 11. Details of defaulters newly added to the list are informed automatically to the child care centres as at L in FIG. 2B by email or other electronic communication means.

Each childcare centre 11 as a member of the system 10 is able to access the central monitoring database 16 to thereby ascertain whether a person or parent who is enrolling a child in their centre has defaulted on payment to another childcare centre 11 and also the debt rating provided that person or parent has by signing an enrolment form agreed to the terms and conditions of enrolment including to the sharing of information about them (for example for debt recovery purposes) or if collection proceedings have been initiated against that person or parent. For communication with the central monitoring database 16, members of the system 10 use their user names and passwords which allows secure login to the system. To have access to the central database 16 via their local computer 13, the software program 12 can provide an enquiry page which is accessible after logon onto the system by a member for entry of data into relevant fields on the enquiry page. Entry of the enquiry through the enquiry page initiates a search of the central database 16 under the field or fields entered. The childcare centre 11 is thus for example able to ascertain whether a person who proposes to enroll a child is a previous defaulter in respect of a debt owing to another child care centre. The childcare centre 11 will also have from the information provided in the central database 16 the debt rating of the debtor and can decide from that rating whether to accept that debtor into their childcare centre and how to manage future payments from that debtor. As an alternative, a child care 11 centre can await receipt from the central computer 17 of the defaulter's list automatically provided to the computer 13 of the child care centre 11 as described above.

In the case of a debt arising to a child care centre 11, the centre may initiate debt collection proceedings using a debt collection agency 18 which is appointed to be part of the system. Debt collection actions can be initiated by the childcare centre 11 by contacting the debt collection agency 18 through the internet or by other communication means via their computer 13 and by providing the debt collection agency 18 with information concerning the debt owing. When the debt collection agency 18 is satisfied that there is a debt proven from information supplied, the agency 18 can access the central monitoring database 16 to obtain information on defaulting users to enable initiation of debt collection actions. That information will usually include the most recent information on the defaulter including the last address of the defaulter. Debt collection proceedings can also be initiated via the central computer 17 by for example highlighting an icon on the website of the central monitoring system 10.

In a further aspect, the central computer 17 is able to alert a child care centre 11 who is seeking to recover a debt from a user who cannot be located if that user is located at another child care centre 11 provided that user is an enrolled member of the child care centre 11 and thus has agreed to the terms and conditions of enrolment in the system 10 or alternatively if collection proceedings have been initiated against that user. Thus if during the software analysis by the central computer 17 of the uploaded user data from all child care centres 11, a user who is owing a debt to one child care centre is located at another child care centre 11 (for example an interstate child care centre 11), that information can be provided as an alert automatically typically by email to the child care centre 11 to which the debt is owing enabling that child care centre 11 to initiate collection proceedings. If the child care centre 11 has placed that debt with the debt collection agency 18, that information can also be provided to the collection agency 18 for action.

To be able to use and be part of the system 10, child care centres 11 are required to be authorised users of the system 10. Authorised users may join the system 10 by paying an annual or monthly fee or other form of consideration. It is possible however that users can be authorised without paying a fee or consideration. As an authorised user, a childcare centre 11 is able to access the central database 16 and in addition have access to the debt collection agency 18 if required. Furthermore, a debt collection agency 18 who is appointed to be part of the system 10 and who has access to the information in the central database 16 may be required to pay a fee to the provider of the system 10 for access to the information. The debt collection agency 18 may have exclusivity in debt collection procedures on defaulting users of the system as recorded in the database 16. Childcare centres 11 however may appoint other debt collection agencies to initiate debt collection procedures. In this case, childcare centres 11 may provide those agencies with debtor information obtained from their local database 14 or alternatively debt collection agencies may access the central database 16 to obtain debtor information.

As authorised users of the system 10, it is likely that bad debt occurrences will reduce. In the event however that bad debts arise, the child care centre 11 is able to use the debt collection agency 18 or other debt collection body for debt recovery purposes.

The system 10 will additionally provide a deterrent effect as if a proposed user of a child care centre 11 is aware that information on or a record of a default payment will be available to all child care centres 11 or member centres 11 of the system 10, they will tend not to default on payments and/or not enroll their child in a centre 11 who is a member of the system 10.

Whilst the invention has been described in relation to operation of a plurality of childcare centres, the system of the invention may be applied to many other equivalent applications where a plurality of service provides provide services to users or where a plurality of businesses supply goods to purchaser. For example a group of different hardware stores may supply goods on credit to purchasers. If a purchaser defaults in payment to one store, other stores will not be aware of the default and therefore be exposed also to a subsequent default in payment by the same purchaser. The use of the debt monitoring system of the present invention in such an application with supplier being a hardware store rather than a child care centre will minimize the risk of this occurring or at least will provide sufficient information to users of the system to be able to determine whether to advance credit to a purchaser. The system of the present invention may therefore be used by a wide range of service providers or suppliers of goods and/or services. A further example is in a private school where fees are paid to the school for education services provided by the school.

The terms “comprising” or “comprises” as used throughout the specification are taken to specify the presence of the stated features, integers and components referred to but not preclude the presence or addition of one or more other feature/s, integer/s, component/s or group thereof.

Whilst the above has been given by way of illustrative embodiment of the invention, all such variations and modifications thereto as would be apparent to persons skilled in the art are deemed to fall within the broad scope and ambit of the invention as defined in the appended claims.

1. A debt monitoring system for use by a plurality of suppliers which supply goods and/or services on credit to respective purchasers of those goods and/or services, each said supplier having data recording means for recording data of each said purchaser, said data including debts to said supplier in respect of goods and/or services provided or to be provided by said supplier to said purchaser and payment records in relation to said debts, and central data recording means for recording said purchaser data from said plurality of suppliers, means for transferring said purchaser data from the data recording means of respective said suppliers to said central data recording means, and means for determining from said transferred purchaser data, the purchasers who do not meet payment conditions prescribed by a said supplier for goods and/or services provided or to be provided by a said supplier.

2. A debt monitoring system as claimed in claim 1 wherein said supplier's data recording means comprises a software programmed computer adapted to receive and store data of all purchasers of the services or goods provided by the supplier including debts owing and payment records.

3. A debt monitoring system as claimed in claim 1 wherein said transfer of purchaser data from the data recording means of a supplier to the central data recording means is triggered by one of automatically at predetermined time or date intervals, under the control of the supplier or as prompted from the central date recording means.

4. A debt monitoring system as claimed in claim 1 wherein said central data recording means includes a central computer having common database in which the purchaser data of all users of suppliers is recorded, said central computer being adapted to analyse the purchasers' data held in the common database and provide a list of defaulting or non-paying purchasers.

5. A debt monitoring system as claimed in claim 4 wherein said list of defaulting purchaser of a supplier is provided to said supplier and wherein means are provided to enable a said supply to remove one or more purchasers from said list.

6. A debt monitoring system as claimed in claim 5 wherein said defaulting purchaser list is provided to the supplier by one of email or through a web site accessible to a said supplier.

7. A debt monitoring system as claimed in claim 6 and including means for providing a credit rating of defaulting purchases in the list of defaulting purchasers.

8. A debt monitoring system as claimed in claim 7 wherein said credit rating is calculated automatically by said central computer during analysis of the payment records of purchasers against the debts owing.

9. A debt monitoring system as claimed in claim 8 wherein said credit rating is based on the time a debit or account has been outstanding and/or the size of the outstanding debit or account.

10. A debt monitoring system as claimed in claim 1 wherein said central computer upon analysis of the purchaser data from respective suppliers is adapted to detect a defaulting purchaser from one supplier whose data is uploaded from another supplier whereby to enable a defaulting purchaser of one supplier to be located from purchaser's data obtained from another supplier.

11. A debt monitoring system as claimed in claim 4 wherein each supplier is required to be a member of the debt monitoring system and wherein membership of said system by said suppliers provides said suppliers with access to the central data recording means to view the list of defaulting purchasers of all member suppliers.

12. A debt monitoring system as claimed in claim 1 and for use in association with a debt collection agency accessible to said suppliers to facilitate recovery of debts due to the supplier and wherein said central data recording means is accessible to said debt collection agency.

13. A debt monitoring system for use by a plurality of child care centers which provide child care services to respective users, each said child care centre having data recording means for recording data of each user of the service provided by said child care centre, said data including debt and payment records of a said user for services provided or to be provided by a said child care centre, and central data recording means for recording said user data from each child care centre, means for transferring said user data from the data recording means of respective said child care centers to said central data recording means, and means determining from said transferred user data, defaulting users who do not meet payment conditions prescribed by a said child care center for child care services provided by a said child care centre.

14. A debt monitoring system as claimed in claim 13 wherein said data recording means of said child care centre comprises a computer and the transfer or uploading of user data from a child care centre to the central data recording means occurs by one of automatically at regular time intervals, under the control of the child care centre, or as prompted from said central data recording means.

15. A debt monitoring system as claimed in claim 14 wherein said computer is software programmed to record the user data of all users of the services provided by the child care centre including debt and payment records of a user for transmission or uploading to said central data recording means.

16. A debt monitoring system as claimed in claim 15 wherein said central data recording means includes a central computer having common database in which the user data of all users of child care centers may be recorded and wherein said central computer is adapted to analyse the user data held in the common database to establish from the debt owing and payment records contained in the user data, defaulting users of child care centers.

17. A debt monitoring system as claimed in claim 16 and including means for providing a list of said defaulting to the child care centre's computer to enable the child care centre to decide or determine whether one or more defaulting users should remain in the list of defaulting users.

18. A debt monitoring system as claimed in claim 17 and including means for providing child care centers with access to said common database to enable a child care centre to view the list of defaulting users of all member child care centers.

19. A debt monitoring system as claimed in claim 17 wherein said central computer upon analysis of said payment records of purchasers against the debts owing is adapted to rate defaulting purchasers in said list with a credit rating.

20. A debt monitoring system as claimed in claim 19 and for use in connection with a debt collection agency accessible to said child care centers for collection of debts owing by defaulting purchasers, said central database being accessible to said debt collection agency.
